(19) United States
(12) Patent Application Publication
(10) Pub. No.: US 2019/0325261 A1
(43) Pub. Date: Oct. 24, 2019

(54) GENERATION OF A CLASSIFIER FROM EXISTING CLASSIFIERS

(71) Applicant: FUJITSU LIMITED, Kawasaki-shi (JP)

(72) Inventor: MITSURU ODA, Setagaya (JP)

(73) Assignee: FUJITSU LIMITED, Kawasaki-shi (JP)

(21) Appl. No.: 16/380,454

(22) Filed: Apr. 10, 2019

(30) Foreign Application Priority Data
Apr. 19, 2018 (JP) 2018-080925

(51) Int. Cl. G06K 9/62; G06N 20/00

(52) U.S. Cl. CPC G06K 9/6227; G06N 20/00; G06K 9/6267; G06K 9/6262

(57) ABSTRACT

An apparatus includes a memory that stores first and second classifier groups that have been learned using a subject that is acquired from an input domain including a plurality of subjects that are to be classified. The apparatus acquires, when correct answer data is input, a vector including evaluation values that are output by the first and second classifier groups as components, and selects a specific classifier group from among the first and second classifier groups, based on a dispersion relationship of the acquired vectors.

### CROSS-REFERENCE TO RELATED APPLICATION

This application is based upon and claims the benefit of priority of the prior Japanese Patent Application No. 2018-80925, filed on Apr. 19, 2018, the entire contents of which are incorporated herein by reference.

### FIELD

The embodiments discussed herein are related to generation of a classifier from existing classifiers.

### BACKGROUND

In recent years, generation of a classifier which classifies input data using machine learning is performed. When a classifier is newly generated, a large quantity of learning data and computer resources used for learning are prepared. However, it is difficult to privately prepare a large quantity of learning data and, as technologies of generating a target classifier using some other classifier, there are parallel ensemble learning (bagging) and transfer learning (fine-tuning). In parallel ensemble learning, a plurality of portions of learning data is collected, many classifiers (weak classifiers) with low accuracy, which use the plurality of portions of learning data as learning date, are generated, and the classifiers with low accuracy are combined to generate a classifier (a strong classifier) with high accuracy. In transfer learning, using internal parameters (for example, weights up to an intermediate layer in deep learning) of an existing classifier, a target classifier is generated.

Japanese Laid-open Patent Publication No. 2011-102792 and Japanese Laid-open Patent Publication No. 2012-145482 discuss the related art.

### SUMMARY

According to an aspect of the embodiments, an apparatus includes a memory that stores first and second classifier groups that have been learned using a subject that is acquired from an input domain including a plurality of subjects that are to be classified. The apparatus acquires, when correct answer data is input, a vector including evaluation values that are output by the first and second classifier groups as components, and selects a specific classifier group from among the first and second classifier groups, based on a dispersion relationship of the acquired vectors.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a configuration of an information processing device according to a first embodiment;

FIG. 2 is a diagram illustrating an example of feature points and feature spaces;

FIG. 3 is a diagram illustrating an example of classification of feature points;

FIG. 4 is a diagram illustrating an example of classification of input data;

FIG. 5 is a flowchart illustrating an example of classifier generation processing according to the first embodiment;

FIG. 6 is a block diagram illustrating an example of a configuration of an information processing device according to a second embodiment;

FIG. 7 is a diagram illustrating an example of a route map;

FIG. 8 is a diagram illustrating an example of a route map storage unit;

FIG. 9 is a diagram illustrating an example of a peripheral information storage unit;

FIG. 10 is a diagram illustrating an example of a single route feature vector storage unit;

FIG. 11 is a diagram illustrating an example of a relationship between a single route set including a start point node and peripheral information;

FIG. 12 is a diagram illustrating an example of a relationship between an existing classifier and peripheral information;

FIG. 13 is a diagram illustrating an example of a single route set used for selection of an existing classifier;

FIG. 14 is a diagram illustrating an example of a feature space that corresponds to a single route set;

FIG. 15 is a diagram illustrating an example of selection of a feature vector of peripheral information;

FIG. 16 is a diagram illustrating an example of route determination;

FIG. 17 is a flowchart illustrating an example of a single route feature vector generation processing according to the second embodiment;

FIG. 18 is a flowchart illustrating an example of existing classifier selection processing according to the second embodiment;

FIG. 19A and FIG. 19B are flowcharts illustrating an example of peripheral information selection processing according to the second embodiment;

FIG. 20 is a flowchart illustrating an example of route determination processing according to the second embodiment; and

FIG. 21 is a diagram illustrating an example of a computer that executes a classifier selection program.

### DESCRIPTION OF EMBODIMENTS

In parallel ensemble learning, a scene in which it is possible to generate many weak classifiers from learning data is assumed, and therefore, unless many existing classifiers which have the same output area as that of a target classifier are included, it is difficult to prepare a sufficient number of weak classifiers. On the other hand, when an existing classifier an output area of which is different from that of a target classifier, that is, a subject of which is a different classification problem is used, a dispersion value for output vectors of the weak classifiers is large and it is difficult to generate a target classifier.

It is preferable to generate a target classifier from the existing non-target classifiers.

With reference to the accompanying drawings, embodiments of a classifier selection method, a classifier selection program, and an information processing device disclosed herein will be described in detail below. Note that the embodiments are not intended to limit a disclosed technology. Also, the following embodiments may be appropriately combined in a range that is not contradictory.

(First Embodiment)

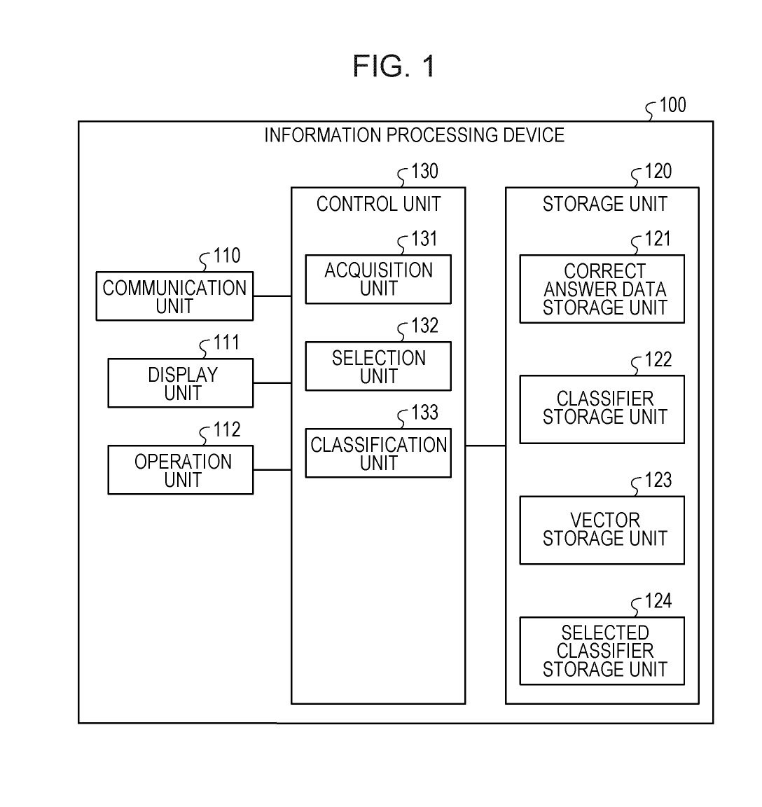

FIG. 1 is a block diagram illustrating an example of a configuration of an information processing device according to a first embodiment. An information processing device 100 illustrated in FIG. 1 is an example of an information processing device that generates a target classifier from a non-target existing classifier group. The information processing device 100 includes first and second classifier groups that have been learned using a subject that is acquired from an input domain including a plurality of subjects that are to be classified. When correct answer data is input, the information processing device 100 acquires a vector that includes, as components, evaluation values that are output by the first and second classifier groups. The information processing device 100 selects a specific classifier group of the first and second classifier groups, based on a dispersion relationship of the acquired vectors. Thus, the information processing device 100 is able to generate a target classifier from a non-target classifier.

As illustrated in FIG. 1, the information processing device 100 includes a communication unit 110, a display unit 111, an operation unit 112, a storage unit 120, and a control unit 130. Note that the information processing device 100 may include, in addition to function units illustrated in FIG. 1, various types of function units, that is, function units, such as for example, various types of input devices, audio output devices, or the like, which a known computer includes.

The communication unit 110 is realized by, for example, a network interface card (NIC) or the like. The communication unit 110 is a communication interface that is coupled to another information processing device via a network that is not illustrated by a wired or wireless communication and controls communication of information with the another information processing device. The communication unit 110 receives correct answer data used for learning or new data that is a determination subject, for example, from another terminal. Also, the communication unit 110 transmits a learning result or a determination result to another terminal.

The display unit 111 is a display device that is used for displaying various types of information. The display unit 111 is realized, for example, as a display device by a liquid crystal display or the like. The display unit 111 displays various types of screens, such as a display screen or the like, which have been input from the control unit 130.

The operation unit 112 is an input device that receives various types of operations from a user of the information processing device 100. The operation unit 112 is realized, for example, as an input device, by a keyboard, a mouse, or the like. The operation unit 112 outputs, as operation information, an operation that has been input by the user to the control unit 130. Note that the operation unit 112 may be realized, as an input device, by a touch panel or the like, and the display device of the display unit 111 and the input device of the operation unit 112 may be integrated as one unit.

The storage unit 120 is realized, for example, by a semiconductor memory, such as a random access memory (RAM), a flash memory, or the like, or a storage device such as a hard disk, an optical disk or the like. The storage unit 120 includes a correct answer data storage unit 121, a classifier storage unit 122, a vector storage unit 123, and a selected classifier storage unit 124. Also, the storage unit 120 stores information that is used for processing in the control unit 130.

The correct answer data storage unit 121 stores, for example, correct answer data of a learning subject, which has been input via the communication unit 110. Note that the correct answer data is a set of pairs of input data and a classification label, which is an example of a correct answer (a specific example of classification) of a target classifier.

The classifier storage unit 122 stores an existing classifier group. The existing classifier group is an existing classifier group including an existing classifier an output area of which is different from that of a target classifier, that is, a subject of which is a different classification problem from that of the target classifier. Also, the existing classifier group is an example of the first and second classifier groups. That is, the existing classifier group includes a plurality of classifiers that have been learned using subjects (classification subjects, such as, for example, a dog, a cat, a red house, a person, a tree, or the like) which are acquired from an input domain (for example, an image) which includes a plurality of subjects that are to be classified. As a classifier, for example, it is possible to use a learning model of a neural network. Also, it is possible to use, as the neural network, various neural networks, such as a recurrent neural network (RNN) or the like.

The vector storage unit 123 stores a vector including, as a component, an evaluation value, that is, for example, a correct answer rate, which is output when correction answer data has been input, in an existing classifier group candidate group CS that has been extracted from the existing classifier group.

The selected classifier storage unit 124 stores the existing classifier group (which will be hereinafter referred to as selected classifiers) which has been selected to form a target classifier. That is, each existing classifier set included in the selected classifiers is equivalent to the target classifier.

For example, a program that is stored in an internal storage device is executed by a central processing unit (CPU), a micro processing unit (MPU), or the like with a RAM serving as a work area, and thereby, the control unit 130 is realized. Also, the control unit 130 may be realized by an integrated circuit, such as, for example, an application specific integrated circuit (ASIC), a field programmable gate array (FPGA), or the like.

The control unit 130 includes an acquisition unit 131, a selection unit 132, and a classification unit 133 and realizes or executes a function or an action of information processing that will be described below. Note that an internal configuration of the control unit 130 is not limited to the configuration illustrated in FIG. 1 and may be some other configuration as long as the configuration is a configuration that performs information processing that will be described later.

The acquisition unit 131 refers to the classifier storage unit 122 and extracts the existing classifier group candidate group CS (which will be also hereinafter referred to as a candidate group CS) from the existing classifier group. A plurality of existing classifier group candidates that are combinations of existing classifiers is included in the candidate group CS. That is, a plurality of existing classifier group candidates is included in the candidate group CS and a plurality of existing classifiers is included in the existing classifier group candidates. Note that the number of the existing classifier group candidates included in the candidate group CS may be an arbitrary number and may be a number up to ten or so.

The acquisition unit 131 refers to the correct answer data storage unit 121, inputs correct answer data to each existing classifier group candidate of the extracted candidate group CS, and acquires a feature vector including a correct answer rate for each existing classifier as a component. That is, the acquisition unit 131 acquires a vector including evaluation values that are output by the first and second classifier groups as components when the correct answer data is input. The acquisition unit 131 stores the acquired feature vector in the vector storage unit 123 for each existing classifier group candidate. When the acquisition unit 131 stores the feature vector in the vector storage unit 123, the acquisition unit 131 outputs a selection instruction to the selection unit 132.

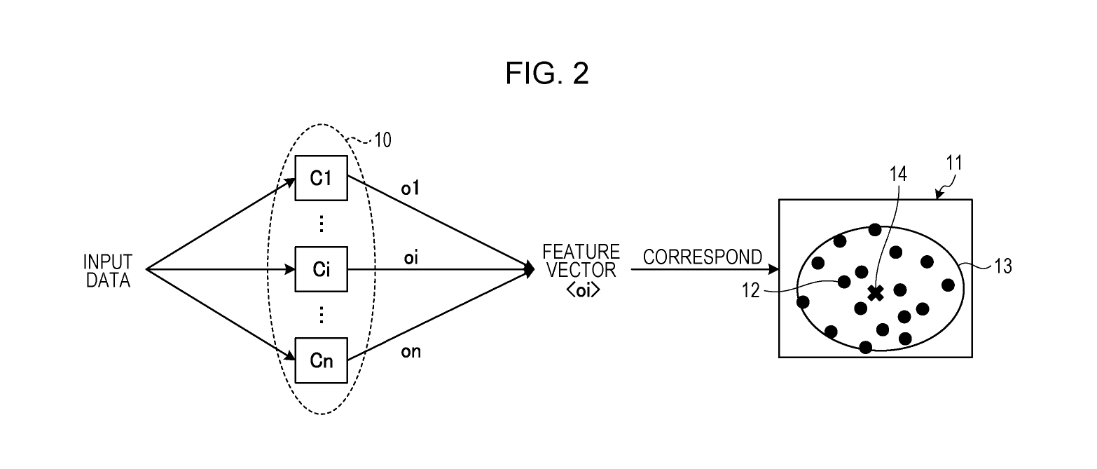

When the selection instruction is input from the acquisition unit 131, the selection unit 132 refers to the vector storage unit 123 and arranges each feature vector as a feature point in a feature space. Note that, because a feature vector corresponds to a feature point, in the following description, a feature point in a feature space will be sometimes expressed as a feature vector. In this case, feature points and feature spaces will be described with reference to FIG. 2. FIG. 2 is a diagram illustrating an example of feature points and feature spaces. As illustrated in FIG. 2, when input data (correct answer data) is input to an existing classifier group candidate 10, classifiers C1, . . . , Ci, . . . , and Cn of the existing classifier group candidate 10 output correct answer rates o1, . . . , o1, . . . , and on, respectively. The acquisition unit 131 acquires a feature vector <oi> including the correct answer rates o1, . . . , oi, . . . , and on as components. The selection unit 132 arranges a feature point 12 that corresponds to the feature vector <oi> in a feature space 11. As for feature points, feature points of a number that correspond to the correction answer data are arranged and a set of feature points which have the same classification is a same classification point set 13. Also, in the feature space 11, the center of gravity of feature points included in the same classification point set 13 is a representative point 14 of the same classification point set 13.

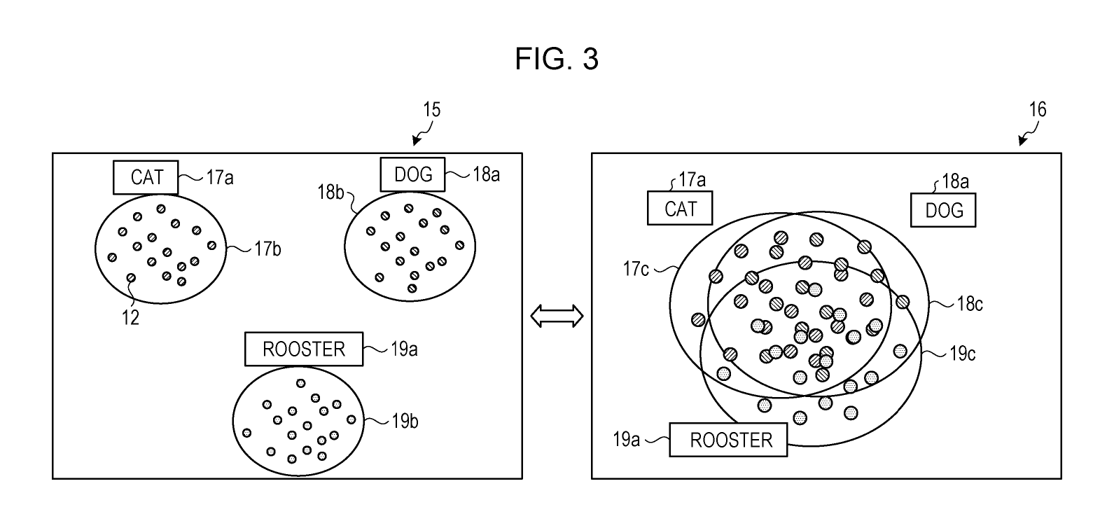

Next, classification of feature points will be described with reference to FIG. 3. FIG. 3 is a diagram illustrating an example of classification of feature points. FIG. 3 illustrates a good classification result 15 and a bad classification result 16 in a case in which correct answer data is classified using the existing classifier group candidate 10. In the good classification result 15, for example, in a case in which classification labels are CAT 17a, DOG 18a, and ROOSTER 19a, respective same classification point sets 17b, 18b, and 19b thereof do not overlap one another. On the other hand, in the bad classification result 16, classification point sets 17c, 18c, and 19c that correspond to the classification labels of CAT 17a, DOG 18a, and ROOSTER 19a, respectively, overlap one another.

That is, it is understood that it is good that the existing classifier group candidate 10 is an existing classifier group that has characteristics (1) and (2) below. The characteristic (1) is that feature vectors in which a distance between feature points is small (a dispersion of the distances is small) in the same classification point set are generated. That is, the characteristic (1) indicates that feature vectors of the correct answer data which has the same classification label are similar to one another. The characteristic (2) is that feature vectors in which a distance between feature points is large in various same classification point sets (a dispersion of distances is large) are generated. That is, the characteristic (2) indicates that the feature vectors of the correction answer data which have different classification labels are not similar to one another.

Accordingly, the existing classifier group candidate 10 is optimally an existing classifier group in which a maximum dispersion value between the same classification points in the same classification point set is minimized and a minimum distance between representative points of the same classification point sets is maximized such that the above described characteristics (1) and (2) are satisfied. However, there may be a case in which an existing classifier which does not satisfy the characteristics (1) and (2) simultaneously, and therefore, the selection unit 132 selects a semi-optimum existing classifier group. Therefore, the selection unit 132 narrows down the existing classifier group candidate 10 in a stepwise manner and selects an existing classifier group that is used for a target classifier.

During stepwise narrowing down, the selection unit 132 removes the existing classifier group candidate 10 in which a dispersion value is equal to or more than an average value of dispersion values in the same classifier point set in a current candidate group CS or a distance between representative points is less than an average value thereof and repeats performing narrowing down on the remaining existing classifier group candidate 10 again. Note that the selection unit 132 may be configured to change the level of pruning of the existing classifier group candidates 10 by setting, instead of the average value of the dispersion value between same classification points (or the distance between representative points), an upper or lower value thereof.

When the selection unit 132 arranges each feature vector as a feature point in a feature space, the selection unit 132 calculates a minimum distance between representative points of the same classification point set. Also, the selection unit 132 calculates a maximum dispersion value between same classification points in the same classification point set for each existing classifier group candidate 10.

The selection unit 132 determines whether or not the number of existing classifier group candidates included in the candidate group CS is “1”. If the selection unit 132 determines that the number of existing classifier group candidates included in the candidate group CS is not “1”, the selection unit 132 calculates an average value of the minimum distances between the representative points of the existing classifier group candidates 10 included in the candidate group CS.

The selection unit 132 calculates an average value of the maximum dispersion values in the same classification point sets of the existing classifier group candidates 10 included in the candidate group CS. The selection unit 132 removes a candidate in which the minimum distance between representative points is less than the average value thereof among the group candidates 10 included in the candidate group CS from the candidate group CS. The selection unit 132 removes a candidate in which the maximum dispersion value in the same classifier point set is the average value thereof or more among the existing classifier group candidates 10 included in the candidate group CS from the candidate group CS. When the selection unit 132 executes narrowing down of the candidate group CS, the selection unit 132 returns to determination on whether or not the number of existing classifier group candidates included in the candidate group CS is “1”.

On the other hand, if the selection unit 132 determines that the number of existing classifier group candidates included in the candidate group CS is “1”, the selection unit 132 stores existing classifier groups included in the existing classifier group candidates 10 as selected classifiers in the selected classifier storage unit 124.

In other words, the selection unit 132 selects a specific classifier group of the first and second classifier groups, based on a dispersion relationship of acquired vectors. Also, the selection unit 132 selects, as the specific classifier group, a classifier group in which a dispersion of distances between feature points in the same classifier point set that is a set of feature points which have a same classification label in a feature space in which vectors are arranged as feature points. Also, the selection unit 132 selects the specific classifier group from classifier groups in which a dispersion of distances between feature points in the same classifier point set is less than an average value. Also, it is assumed that the center-of-gravity points of feature points in a plurality of same classification point sets are representative points, and then, the selection unit 132 calculates a minimum distance of distances between the representative points and selects the specific classifier group from classification groups in which the minimum distance is the average value or more.

Returning to description of FIG. 1, after the selected classifiers are stored in the selected classifier storage unit 124, the classification unit 133 acquires new data and outputs a classification result of classification that has been performed using the selected classifiers. The classification unit 133 receives and acquires the new data of a classification subject from another terminal, for example, via the communication unit 110. The classification unit 133 refers to the selected classifier storage unit 124 and classifies the new data that has been acquired using the selected classifiers. The classification unit 133 outputs the classification result to the display unit 111 to display the classification result thereon or outputs the classification result to the storage unit 120 to store the classification result therein. That is, the classification unit 133 classifies an input data group using the specific classifier group that has been selected.

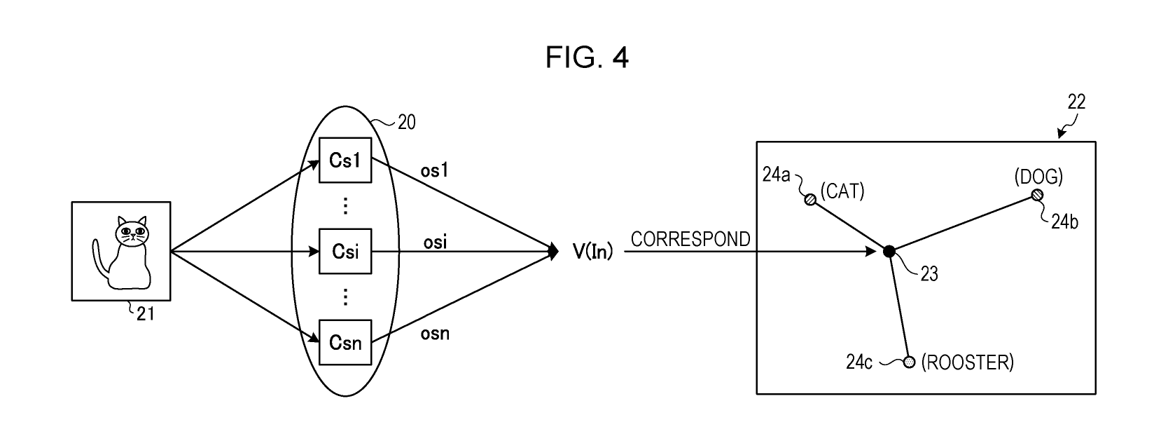

In this case, with reference to FIG. 4, classification of new data (input data) will be described. FIG. 4 is a diagram illustrating an example of classification of input data. As illustrated in FIG. 4, when new data 21 is input to a selected classifier 20, existing classifiers Cs1, . . . , Csi, . . . , and Csn of the selected classifier 20 output correct answer rates os1, . . . , osi, . . . , and osn, respectively. The classification unit 133 acquires a feature vector V<In> including the correct answer rates os1, . . . , osi, . . . , and osn as components. The classification unit 133 arranges a feature point 23 that corresponds to the feature vector V<In> in a feature space 22. The classification unit 133 determines to which one of representative points 24a, 24b, and 24c of classification labels “CAT, “DOG”, and “ROOSTER” the feature point 23 that has been arranged is closest. In the example of FIG. 4, the classification unit 133 determines that the feature point 23 is closest to the representative point 24a and outputs, as a classification result for the new data 21, the classification label “CAT”.

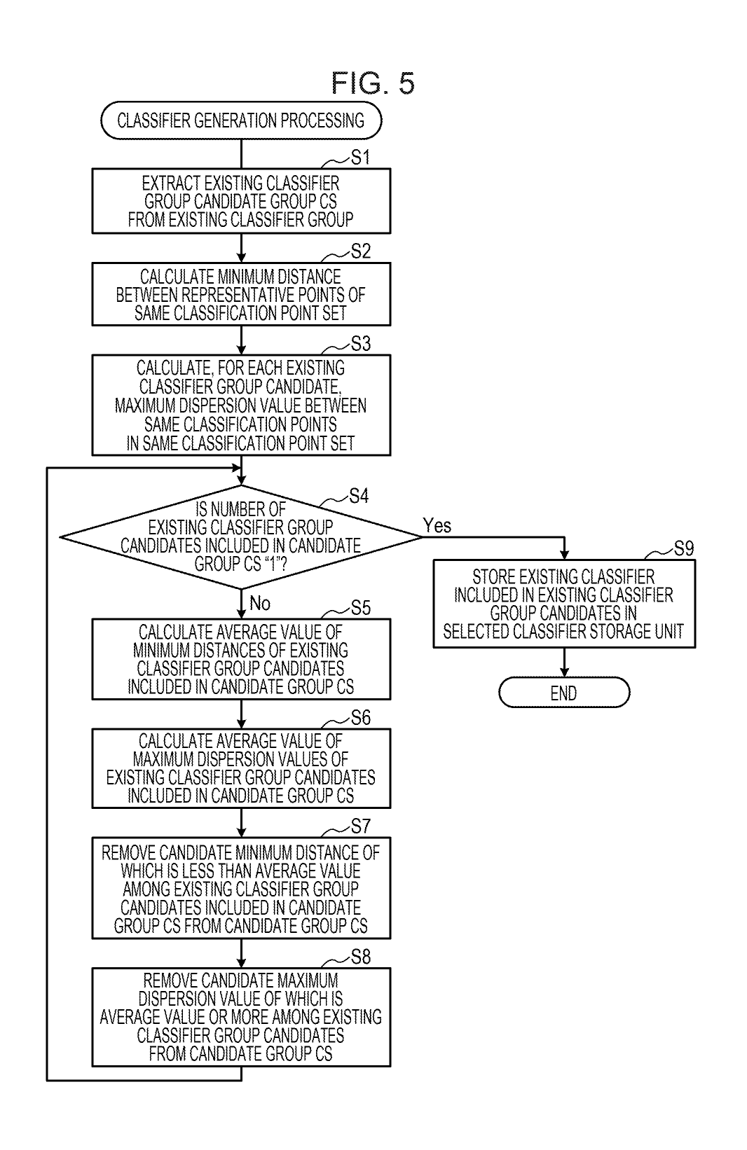

Next, an operation of the information processing device 100 of the first embodiment will be described with reference to FIGS. 1 and 5. FIG. 5 is a flowchart illustrating an example of classifier generation processing according to the first embodiment.

When classifier generation processing is started, the acquisition unit 131 refers to the classifier storage unit 122 and extracts an existing classifier group candidate group CS from an existing classifier group (Step S1). The acquisition unit 131 refers to the correct answer data storage unit 121, inputs correct answer data to each of existing classifier group candidates of the extracted candidate group CS, and acquires a feature vector that includes a correct answer rate for each existing classifier as a component. The acquisition unit 131 stores the acquired feature vector in the vector storage unit 123 for each existing classifier group candidate. When the acquisition unit 131 stores the feature vector in the vector storage unit 123, the acquisition unit 131 outputs a selection instruction to the selection unit 132.

When the selection instruction is input from the acquisition unit 131, the selection unit 132 refers to the vector storage unit 123 and arranges each feature vector as a feature point in a feature space. The selection unit 132 calculates a minimum distance between representative points of a same classifier point set (Step S2). Also, the selection unit 132 calculates a maximum dispersion value between same classification points in the same classification point set for each existing classifier group candidate 10 (Step S3).

The selection unit 132 determines whether or not the number of existing classifier group candidates included in the candidate group CS is “1” (Step S4). If the selection unit 132 determines that the number of existing classifier group candidates included in the candidate group CS is not “1” (NO in Step S4), the selection unit 132 calculates an average value of the minimum distances between representative points of the existing classifier group candidates 10 included in the candidate group CS (Step S5).

The selection unit 132 calculates an average value of the maximum dispersion values in the same classifier point set of the existing classifier group candidates 10 included in the candidate group CS (Step S6). The selection unit 132 removes a candidate in which the minimum distance between representative points is less than the average value among the existing classifier group candidates 10 included in the candidate group CS from the candidate group CS (Step S7). The selection unit 132 removes a candidate in which the maximum dispersion value in the same classification point set is the average value or more among the existing classifier group candidates 10 included in the candidate group CS from the candidate group CS (Step S8) and the process returns to Step S4.

On the other hand, if the selection unit 132 determines that the number of existing classifier group candidates included in the candidate group CS is “1” (YES in Step S4), the selection unit 132 stores existing classifier groups included in the existing classifier group candidates 10 as selected classifiers in the selected classifier storage unit 124 (Step S9) and the process is terminated. Thus, the information processing device 100 is able to generate a target classifier from a non-target classifier. Also, the information processing device 100 is able to use an existing classifier as it is, and therefore, it is possible to reduce classifier development costs, such as calculation costs or the like used for preparation or learning of learning data. Also, in the information processing device 100, it is possible to use input of a classifier not only for input of an image but also for multimodal input that simultaneously uses a voice or the like. Also, in the information processing device 100, it is possible to reuse a classifier and increase an application range of a developed classifier.

Note that, although, in the above described first embodiment, the number of existing classifier group candidates that are selected classifiers is “1”, the number of the existing classifier group candidates is not limited thereto. For example, the number of the existing classifier group candidates may be a predetermined number of two or more.

As described above, the information processing device 100 includes the first and second classifier groups that have been learned using a subject that is acquired from an input domain including a plurality of subjects that are to be classified. Also, when correct answer data is input, the information processing device 100 acquires a vector including evaluation values that are output by the first and second classifier groups as components. Also, the information processing device 100 selects a specific classifier group of the first and second classifier groups, based on a dispersion relationship of the acquired vectors. As a result, the information processing device 100 is able to generate a target classifier from a non-target classifier.

Also, the information processing device 100 selects, as a specific classifier group, a classifier group in which a distance between feature points in a same classification point set that is a set of feature points that have a same classifier label in a feature space in which vectors have been arranged as feature points is small. As a result, the information processing device 100 is able to increase classification accuracy.

Also, the information processing device 100 selects a specific classifier group from classifier groups in which a dispersion of distances between feature points in the same classification point set is less than an average value. As a result, the information processing device 100 is able to increase classification accuracy.

Also, the information processing device 100 assumes that centers of gravity of feature points in a plurality of classification point sets are representative points, calculates a minimum distance of distances between the representative points, and selects a specific classifier group from classifier groups in which the minimum distance is an average value or more. As a result, the information processing device 100 is able to increase classification accuracy.

Also, the information processing device 100 classifies an input data group using the selected specific classifier group. As a result, the information processing device 100 is able to perform target classification using an existing non-target classifier.

(Second Embodiment)

In the above described first embodiment, generation of a target classifier has been described, but the first embodiment may be applied to route determination, and an embodiment in this case will be described as a second embodiment. Note that each component that is the same as a corresponding one of the information processing device 100 of the first embodiment will be denoted by the same reference symbol as that in the first embodiment and thereby redundant description of the same component and operation will be omitted.

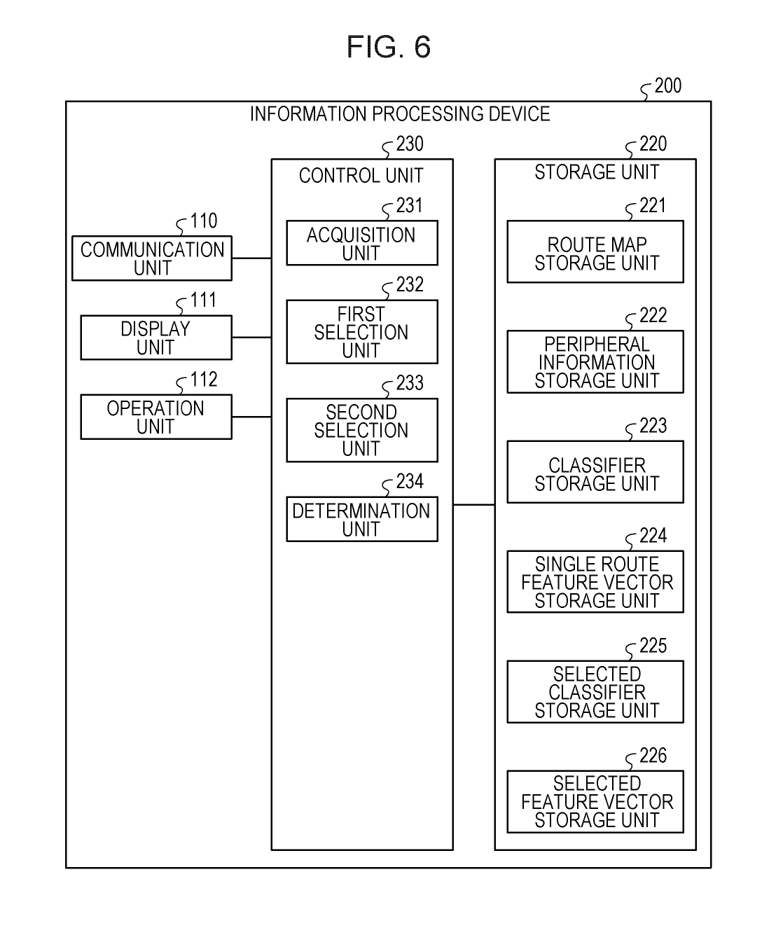

FIG. 6 is a block diagram illustrating an example of a configuration of an information processing device according to a second embodiment. As compared to the information processing device 100 of the first embodiment, an information processing device 200 illustrated in FIG. 6 includes, instead of the storage unit 120 and the control unit 130, a storage unit 220 and a control unit 230.

The storage unit 220 includes a route map storage unit 221, a peripheral information storage unit 222, a classifier storage unit 223, a single route feature vector storage unit 224, a selected classifier storage unit 225, and a selected feature vector storage unit 226.

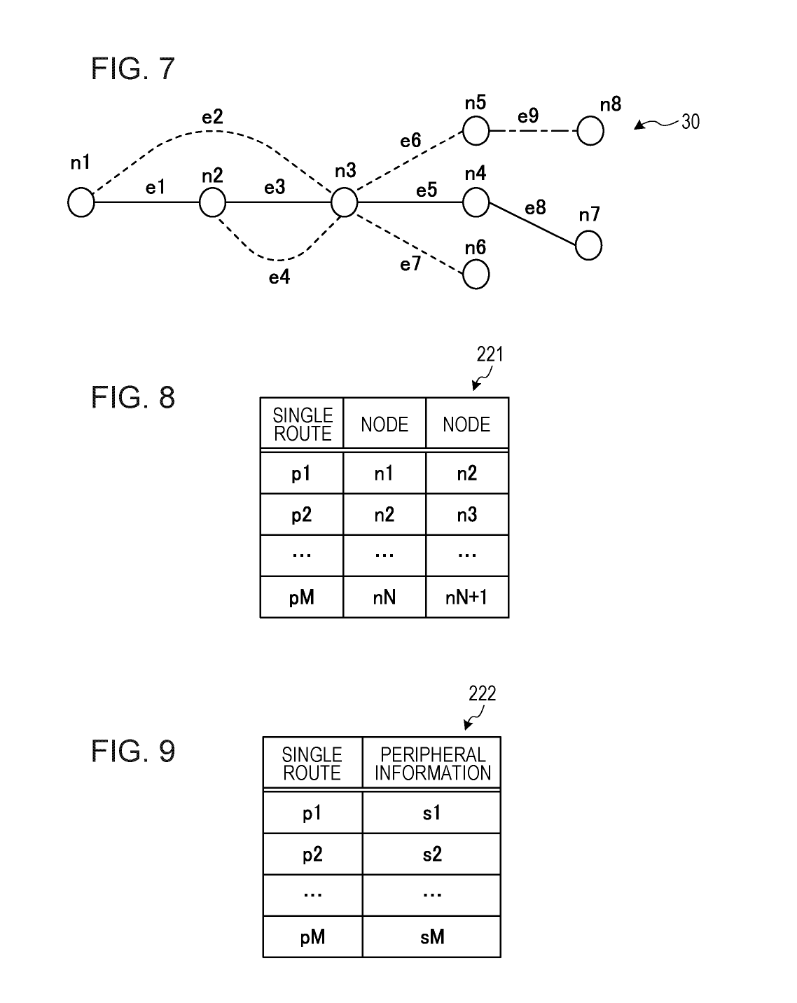

In this case, a route map will be described with reference to FIG. 7. FIG. 7 is a diagram illustrating an example of a route map. A route map 30 illustrated in FIG. 7 represents a map in a graph structure and includes nodes n1 to n8, and a route that corresponds to an edge is called single route. Also, in the route map 30, a route from the node n1 to the node n7 via the nodes n2, n3, and n4 is denoted by a route pr<e1, e3, e5, e8>. As used herein, a route is a sequence of single routes, which extends from a node of a start point to a node of an end point and does not includes a chain. Also, the route pr is a designated route that has been designated as a moving route. In this case, a single route on the route pr is called a correct single route for the route pr and other single routes are called wrong single routes for the route pr. Specifically, a wrong single route that branches off from the route pr is called a neighboring wrong single route for the route pr. In the route map 30, for the route pr<e1, e3, e5, e8>, single routes e1, e3, e5, and e8 are correct single routes, single routes e2, e4, e6, and e7 are neighboring wrong single routes, and a single route e9 is a wrong single route. Also, in description below, an image, a voice, or the like that have been acquired in a point on a route will be referred to as peripheral information.

The route map storage unit 221 stores a route map that represents map information expressed in a graph in a table format. FIG. 8 is a diagram illustrating an example of a route map storage unit. As illustrated in FIG. 8, the route map storage unit 221 includes items, such as “SINGLE ROUTE”, “NODE”, and “NODE”. The route map storage unit 221 stores, for example, the route map as one record for each single route.

“SINGLE ROUTE” is information that indicates a label of a single route. “NODE” is information that indicates each of labels of nodes at both ends of the single route. In an example in a first row in FIG. 8, a single route “p1” indicates a single route that connects the nodes “n1” and “n2”.

Returning to description of FIG. 6, the peripheral information storage unit 222 stores peripheral information for each single route in association with a corresponding singe route. FIG. 9 is a diagram illustrating an example of a peripheral information storage unit. As illustrated in FIG. 9, the peripheral information storage unit 222 includes items, such as “SINGLE ROUTE” and “PERIPHERAL INFORMATION”. The peripheral information storage unit 222 stores, for example, peripheral information as one record for each single route.

“SINGLE ROUTE” is information that indicates a label of a single route. “PERIPHERAL INFORMATION” is information that indicates peripheral information that has been acquired around a single route that is indicated by a single route label. The peripheral information is, for example, information of an image or a voice. In an example in a first row in FIG. 9, it is indicated that peripheral information “s1” is associated with the single route “p1”.

Returning to description of FIG. 6, the classifier storage unit 223 stores an existing classifier group. The classifier storage unit 223 corresponds to the classifier storage unit 122 of the first embodiment.

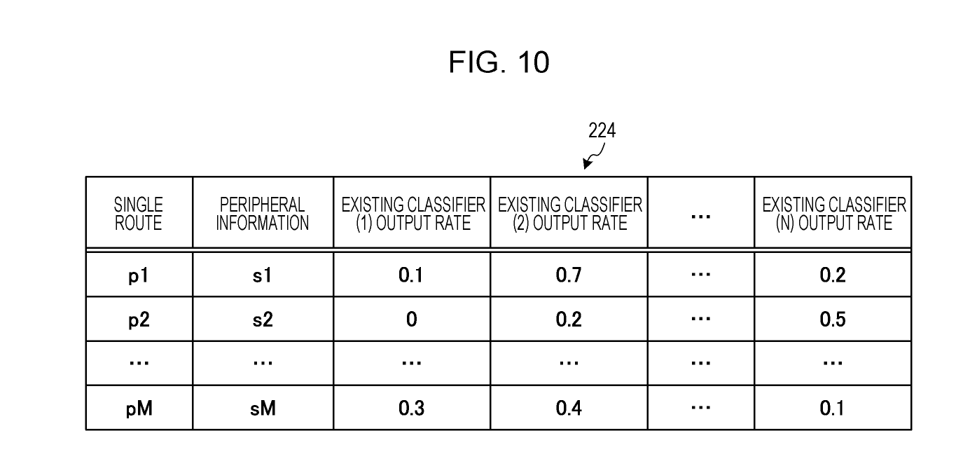

The single route feature vector storage unit 224 stores a single route, peripheral information, and an output rate of each existing classifier in association with one another. FIG. 10 is a diagram illustrating an example of a single route feature vector storage unit. As illustrated in FIG. 10, the single route feature vector storage unit 224 includes items, such as “SINGLE ROUTE”, “PERIPHERAL INFORMATION”, and “EXISTING CLASSIFIER (N) OUTPUT RATE”. The single route feature vector storage unit 224 stores, for example, the single route, the peripheral information, and the output rate of each existing classifier as one record for each single route.

“SINGLE ROUTE” is information that indicates a label of a single route. “PERIPHERAL INFORMATION” is information that indicates peripheral information that has been acquired around a single route that is indicated by a single route label. “EXISTING CLASSIFIER (N) OUTPUT RATE” is information that indicates a correct answer rate (a rate at which an identification result is established) which is output in a case in which peripheral information is input to each of existing classifiers 1 to N.

Returning to description of FIG. 6, the selected classifier storage unit 225 stores a selected classifier. The selected classifier storage unit 225 corresponds to the selected classifier storage unit 124 of the first embodiment.

The selected feature vector storage unit 226 stores a feature vector group that has been selected as a feature vector group that corresponds to peripheral information in which similarity of each single route is lower among feature vector groups of peripheral information that corresponds to each single route of a route set including a start point (terminal point) node.

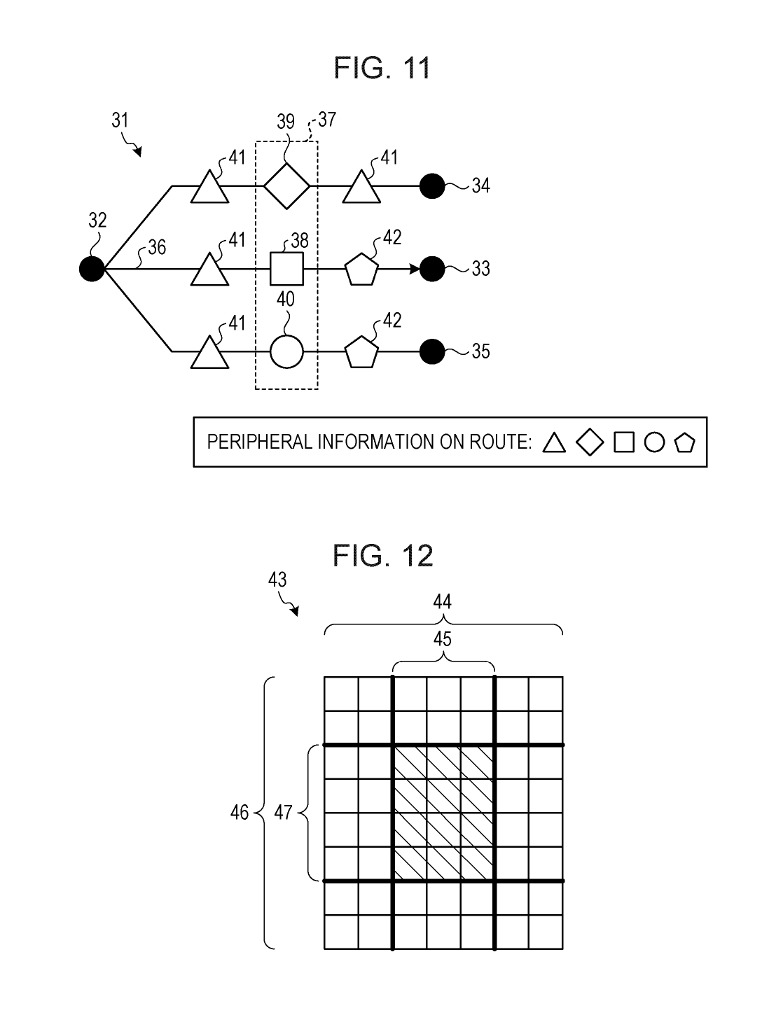

FIG. 11 is a diagram illustrating an example of a relationship between a single route set including a start point node and peripheral information. A single route set 31 illustrated in FIG. 11 includes a start point node 32, an end node 33, and other nodes 34 and 35. It is assumed that a designated route 36 is a single route (a correct single route) which connects the start point node 32 and the end node 33. Also, it is assumed that a single route that connects the start point node 32 and another node 34 and a single route that connects the start point node 32 and another node 35 are neighboring wrong single routes. In route determination, it is preferable that, in each single route, peripheral information 37 in which similarity with another route is low exists.

The peripheral information 37 includes, for example, peripheral information 38 that characterizes the designated route 36, peripheral information 39 that characterizes a neighboring wrong single route to the another node 34, and peripheral information 40 that characterizes a neighboring wrong single route to the another node 35. In the information processing device 200, each of feature vectors of the peripheral information 38, 39, and 40 that are usable for route determination as described above is selected and is used. That is, in the example of FIG. 11, the selected feature vector storage unit 226 stores each of the feature vectors of the peripheral information 38, 39, and 40. Note that peripheral information 41 and 42 appears in a plurality of single routes, and therefore, is not peripheral information that characterizes each single route.

FIG. 12 is a diagram illustrating an example of a relationship between an existing classifier and peripheral information. A graph 43 illustrated in FIG. 12 indicates a relationship between a usable existing classifier 44, a selected classifier 45 that is an existing classifier that is used, usable peripheral information 46, and peripheral information (selected feature vector) 47 that is used. It is assumed that, in the graph 43, there are 56 outputs that correspond to a combination of the existing classifier 44 and the peripheral information 46. In contrast, there are 12 outputs that correspond to a combination of the selected classifier 45 and the peripheral information 47. That is, even when a large quantity of peripheral information is input, outputs other than outputs that correspond to the combination of the selected classifier 45 and the peripheral information 47, which is used for route determination, may not be used. That is, in the second embodiment, as compared to the first embodiment, not only a classifier but also a feature vector that corresponds to peripheral information of each single route is selected.

That is, in the second embodiment, existing classifier groups diverse in order to handle various types of information, and therefore, many existing classifiers are used. However, as indicated in the graph 43, if many existing classifiers are used as they are for generation of a feature vector of peripheral information, a storage area and a calculation processing amount are increased. Therefore, in the second embodiment, the selected classifier 45 that is a useful existing classifier is desirable to be distinguished from the usable existing classifier 44.

Returning to description of FIG. 6, for example, a program stored in an internal storage device is executed by a CPU, an MPU, or the like with a RAM serving as a work area, and thereby, the control unit 230 is realized. Also, the control unit 230 may be realized, for example, by an integrated circuit, such as an ASIC, an FPGA, or the like.

The control unit 230 includes an acquisition unit 231, a first selection unit 232, a second selection unit 233, and a determination unit 234 and realizes or executes a function or an action of information processing that will be described below. Note that an internal configuration of the control unit 230 is not limited to the configuration illustrated in FIG. 6 and may be some other configuration as long as the configuration is a configuration that performs information processing that will be described later.

In addition to the acquisition unit 131 of the first embodiment, the acquisition unit 231 acquires, based on peripheral information that characterizes a designated route, a feature vector group that corresponds to the peripheral information in accordance with a single route set including a start point node of the designated route. Specifically, the acquisition unit 231 acquires information of each single route from the route map storage unit 221. The acquisition unit 231 acquires peripheral information in each single route from the peripheral information storage unit 222.

The acquisition unit 231 acquires an existing classifier from the classifier storage unit 223 and applies the peripheral information of each single route to the existing classifier. The acquisition unit 231 stores an output of the existing classifier for the peripheral information in each single route to the single route feature vector storage unit 224.

The first selection unit 232 corresponds to the selection unit 132 of the first embodiment and selects an existing classifier. The first selection unit 232 arranges a feature vector of each single route as a feature point in a feature space for each single route set. The first selection unit 232 assumes that centers of gravity of feature points included in same classification point sets each of which is a set of feature points that have a same classification label are representative points and calculates a minimum distance of distances between the representative points. For example, the first selection unit 232 selects one existing classifier that corresponds to a feature point at random and removes the existing classifier from the existing classifier group. The first selection unit 232 determines whether or not the minimum distance is increased in this case.

The first selection unit 232 sets, if the minimum distance is increased, the existing classifier group from which the selected existing classifier has been removed as a selected classifier. The first selection unit 232 sets, if the minimum distance is not increased, the existing classifier group from which the selected existing classifier has not been removed as a selected classifier. The first selection unit 232 sets remaining existing classifier groups in the existing classifier group as selected classifiers that are used by repeating the above described operation. The first selection unit 232 stores the selected classifiers in the selected classifier storage unit 225.

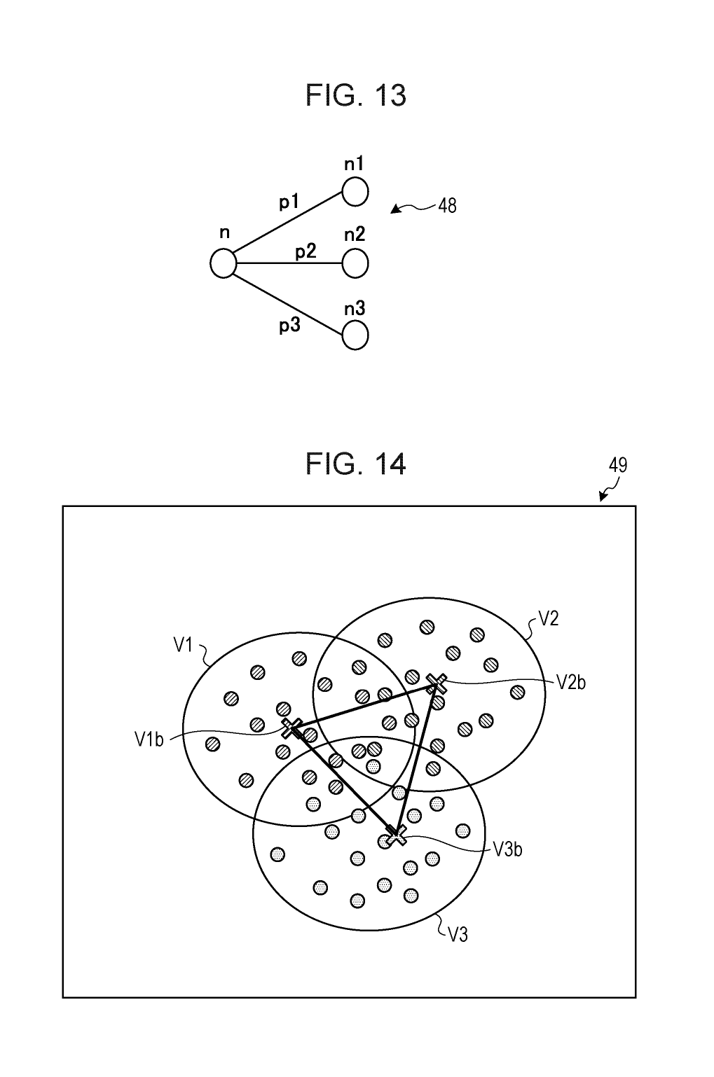

FIG. 13 is a diagram illustrating an example of a single route set used for selection of an existing classifier. A single route set 48 illustrated in FIG. 13 is a single route set in which a node n is a start point (a terminal point). A feature space that corresponds to the single route set 48 is illustrated in FIG. 14. FIG. 14 is a diagram illustrating an example of a feature space that corresponds to a single route set. In a feature space 49 illustrated in FIG. 14, a same classification point set V1 that is a set of feature points that correspond to a single route p1 included in the single route set 48, a same classification point set V2 that corresponds to a single route p2 in a similar manner, and a same classification point set V3 that corresponds to a single route p3 in a similar manner are arranged. In this case, the centers of gravity (center-of-gravity vectors) of the same classification point sets V1, V2, and V3 are representative points V1b, V2b, and V3b, respectively. In this case, the minimum distance of each of the representative points V1b, V2b, and V3b indicates similarity. That is, as the minimum distance increases, classification accuracy increases.

The second selection unit 233 selects peripheral information. The second selection unit 233 refers to the single-route feature vector storage unit 224 and arranges a feature vector group that corresponds to a single route set as a feature point in a feature space. The second selection unit 233 sets a set of feature points for each same single route as a first feature vector set and calculates a center-of-gravity vector for each set. The second selection unit 233 calculates distances between the center-of-gravity vectors of all of single routes included in the single route set. The second selection unit 233 selects, among feature vectors included in the feature vector group, a second feature vector set after removing a feature vector in which a distance from the center-of-gravity vector of the first feature vector set to which the single route itself does not belong is smaller than the distance between the centers of gravity from the feature vector group. The second selection unit 233 stores the selected second feature vector set in the selected feature vector storage unit 226.

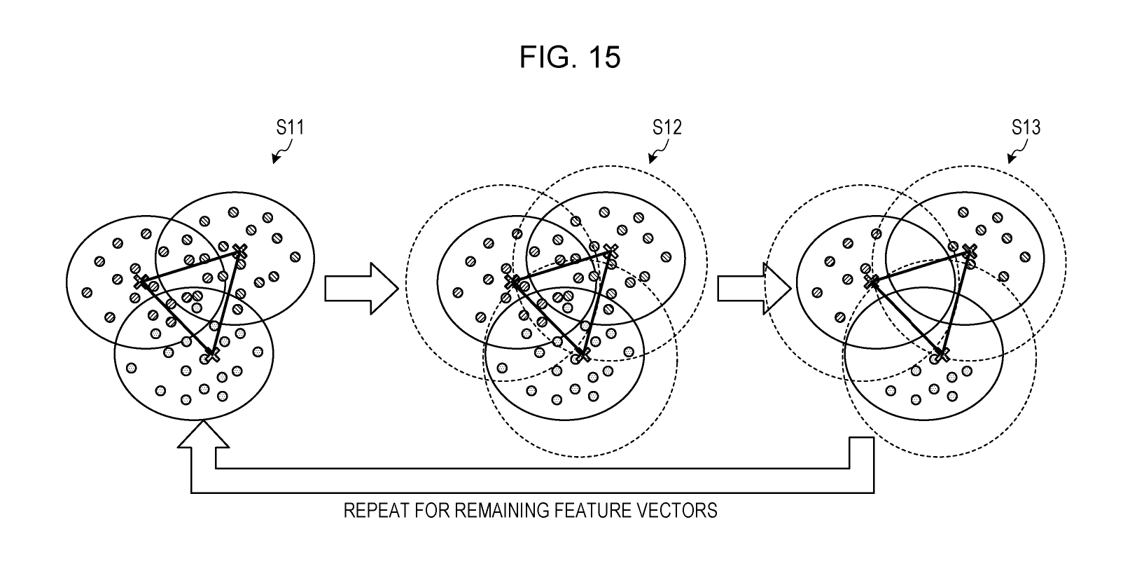

FIG. 15 is a diagram illustrating an example of selection of a feature vector of peripheral information. As illustrated in FIG. 15, the second selection unit 233 arranges a feature vector group that corresponds to a single route set as a feature point in a feature space and calculates a center of gravity for each first feature vector set (Step S11). The second selection unit 233 evaluates, for a feature point that corresponds to each feature vector, a distance from the center of gravity of the first feature vector set to which the single route itself does not belong (Step S12). The second selection unit 233 removes a feature vector in which the evaluated distance is smaller than a distance between the center-of-gravity vectors from the feature vector group (Step S13). The second selection unit 233 repeats Steps S11 to S13 for remaining feature vectors until the number of feature vectors is a prescribed number or less. Note that the prescribed number may be an arbitrary number and, for example, may be one to ten or so. The second selection unit 233 selects, as the second feature vector set, a feature vector group in a case in which the number of feature vectors is the prescribed number or less.

Returning to description of FIG. 6, the determination unit 234 acquires peripheral information that is new data and outputs a determination result of determination of the acquired peripheral information using a selected classifier that corresponds to a designated route and the second feature vector. The determination unit 234 acquires the designated route, based on an instruction from the user or the like. The determination unit 234 sets a node n of interest as a start point of the designated route. The determination unit 234 refers to the route map storage unit 221 and acquires a single route group Pn a terminal point of which is the node n of interest. The determination unit 234 refers to the selected classifier storage unit 225 and acquires a selected classifier that corresponds to the single route group Pn. Also, the determination unit 234 refers to the selected feature vector storage unit 226 and acquires a second feature vector set that includes selected feature vectors that correspond to the single route group Pn.

When input of peripheral information of a route determination subject, for example, from an imaging device that is not illustrated is started, the determination unit 234 acquires the peripheral information that has been input. The determination unit 234 determines a current single route, based on a feature vector that corresponds to the peripheral information, a selected classifier, and the second feature vector set. That is, the determination unit 234 determines the current single route, based on a specific classifier group that has been selected and the second feature vector set that has been selected. The determination unit 234 outputs a determination result to the display unit 111 to display the determination result thereon or outputs the determination result to the storage unit 220 to store the determination result therein. That is, the determination unit 234 takes out from current peripheral information a feature vector thereof, compares the feature vector to a feature vector of peripheral information (a landmark) of an estimated single route, and determines, if the feature vectors match one another or have high similarity, that the user is on the single route.

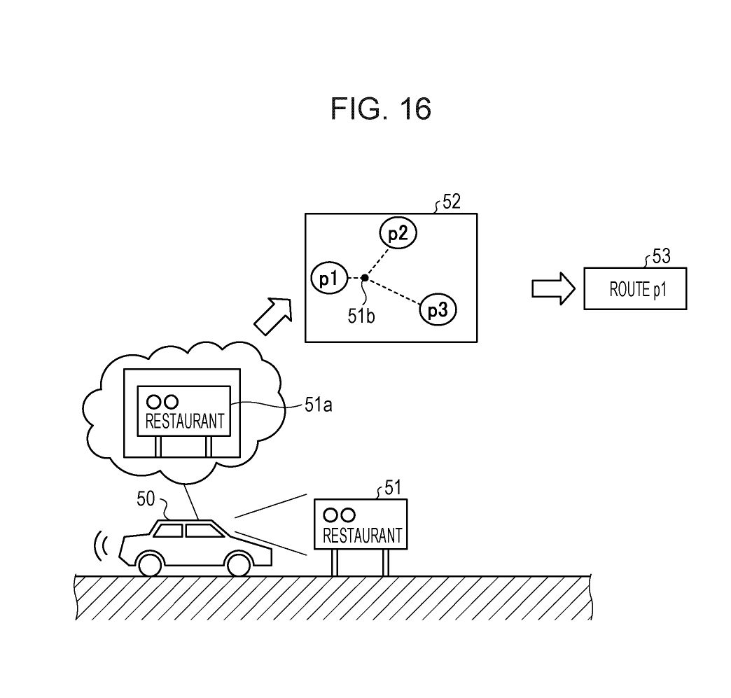

FIG. 16 is a diagram illustrating an example of route determination. In the example of FIG. 16, a case in which the information processing device 200 is mounted on an automobile 50 and route determination is performed is illustrated. When the automobile 50 departs from a start point node of a designated route, the information processing device 200 starts acquiring peripheral information using an imaging device that is not illustrated. The information processing device 200 starts determination of a current single rout, based on a selected classifier that correspond to the designated route and the second feature vector set. When the automobile 50 approaches a signboard 51, the information processing device 200 acquires peripheral information 51a that has been obtained by imaging the signboard 51. The information processing device 200 plots a feature vector 51b that corresponds to the peripheral information 51a in a feature space that corresponds to the selected classifier and the second feature vector set. The information processing device 200 outputs a current single route p1 as a determination result 53 because the feature vector 51b is closest to the second feature vector set [p1]. Thus, the information processing device 200 is able to determine a current route.

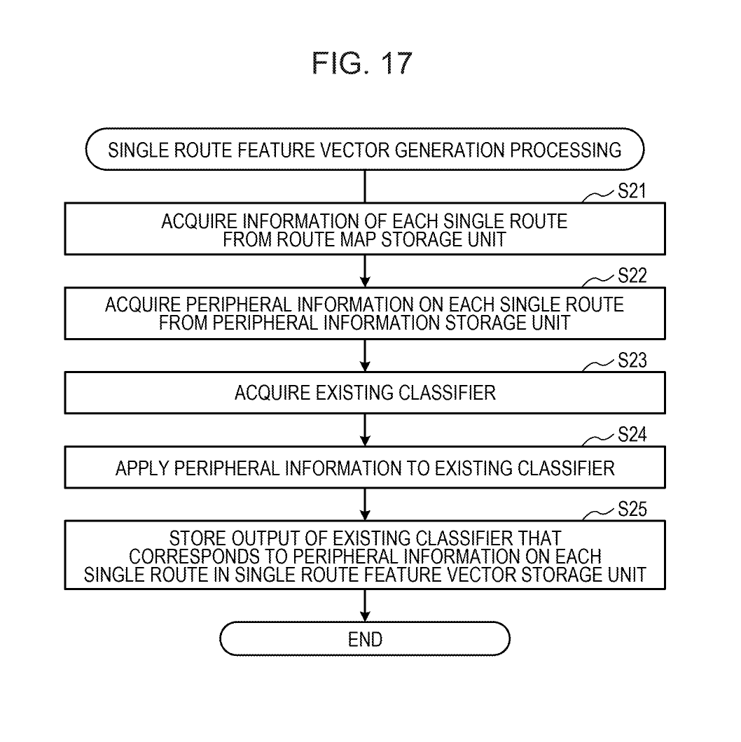

Next, an operation of the information processing device 200 of the second embodiment will be described. First, single route feature vector generation processing will be described. FIG. 17 is a flowchart illustrating an example of a single route feature vector generation processing according to the second embodiment.

The acquisition unit 231 acquires information of each single route from the route map storage unit 221 (Step S21). The acquisition unit 231 acquires peripheral information in each single route from the peripheral information storage unit 222 (Step S22).

The acquisition unit 231 acquires an existing classifier from the classifier storage unit 223 (Step S23) and applies peripheral information of each single route to the existing classifier (Step S24). The acquisition unit 231 stores an output of the existing classifier for the peripheral information on each single route in the single route feature vector storage unit 224 (Step S25). Thus, the information processing device 200 is able to generate an output rate of each existing classifier that corresponds to the peripheral information of each single route.

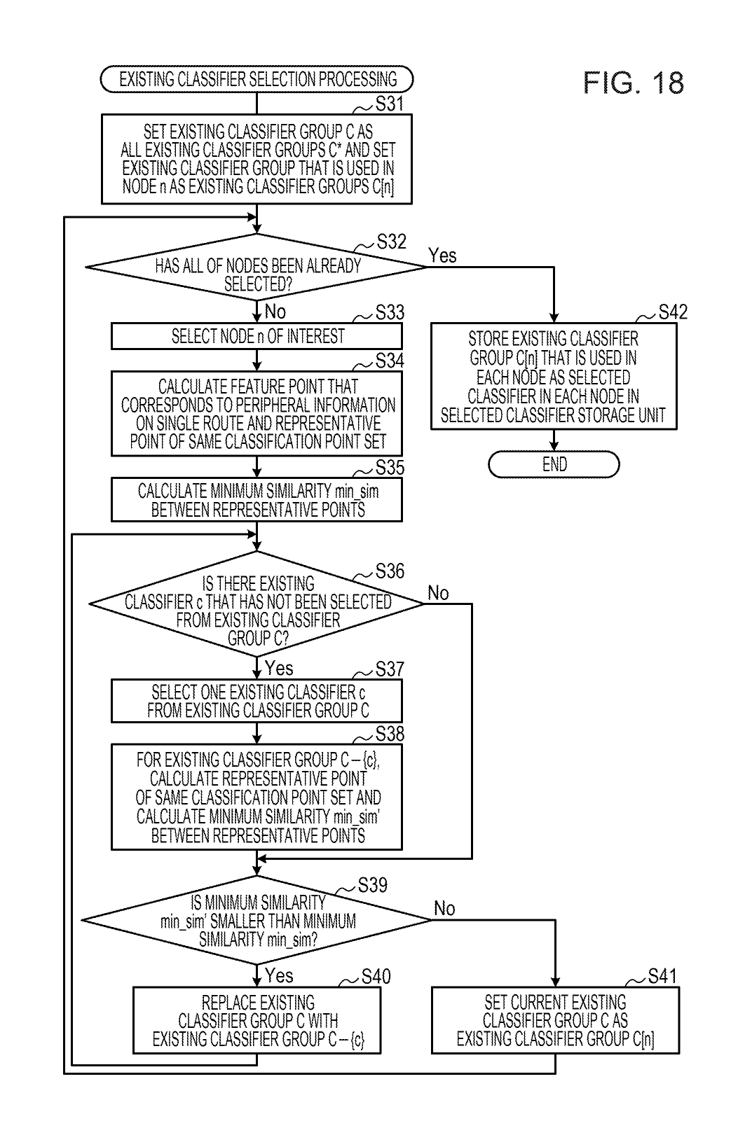

Subsequently, existing classifier selection processing will be described. FIG. 18 is a flowchart illustrating an example of existing classifier selection processing according to the second embodiment.

Existing classifier selection processing will be described using an existing classifier group C, an existing classifier c, a node n of interest, and a minimum similarity min_sim between representative points. Note that the minimum similarity min_sim corresponds to a minimum distance.

The first selection unit 232 sets the existing classifier group C as an all-existing classifier group C*. Also, the first selection unit 232 sets an existing classifier group that is used in the node n as an existing classifier group C[n] (Step S31).

The first selection unit 232 determines whether or not all of nodes have been already selected (Step S32). If the first selection unit 232 determines that all of nodes have been already selected (YES in Step S32), the process proceeds to Step S42. If the first selection unit 232 determines that all of nodes have not been selected yet (NO in Step S32), the first selection unit 232 selects the node n of interest (Step S33).

The first selection unit 232 calculates, for each single route a terminal point of which is the node n, a feature point that corresponds to each peripheral information (an image or the like) on the single route and a representative point (a center-of-gravity vector) which is the center of gravity of a same classification point set (Step S34).

The first selection unit 232 calculates the minimum similarity min_sim between representative points (Step S35). Note that, for similarity, a cosine correlation value may be used.

The first selection unit 232 determines whether or not there is the existing classifier c that has not been selected from the existing classifier group C (Step S36). If the first selection unit 232 determines that there is not the existing classifier c that has not been selected (NO in Step S36), the process proceeds to Step S39. If the first selection unit 232 determines that there is the existing classifier c that has not been selected (YES in Step S36), the first selection unit 232 selects one existing classifier c from the existing classifier group C (Step S37).

The first selection unit 232 calculates, for an existing classifier group C-{c} obtained by removing the selected existing classifier c from the existing classifier group C, a representative point of the same classification point set. The first selection unit 232 calculates minimum similarity min_sim′ between the calculated representative points (Step S38). That is, the first selection unit 232 calculates the minimum similarity min_sim′ between the representative points, which corresponds to the existing classifier group C-{c}.

The first selection unit 232 determines whether or not the minimum similarity min_sim′ is smaller than the minimum similarity min_sim (Step S39). That is, the first selection unit 232 determines whether or not the minimum distance in the existing classifier group C-{c} is larger than the minimum distance in the existing classifier group C. If the first selection unit 232 determines that the minimum similarity min_sim′ is smaller than the minimum similarity min_sim (YES in Step S39), the first selection unit 232 replaces the existing classifier group C with the existing classifier group C-{c} (Step S40) and the process returns to Step S36.

If the first selection unit 232 determines that the minimum similarity min_sim′ is the minimum similarity min_sim or more (NO in Step S39), the first selection unit 232 sets a current existing classifier group C as the existing classifier group C[n] (Step S41) and the process returns to the Step S32.

If YES in Step S32, the first selection unit 232 stores, as a selected classifier in each node, the existing classifier group C[n] that is used in each node in the selected classifier storage unit 225 (Step S42) and existing classifier selection processing is terminated. Thus, the information processing device 200 is able to select each existing classifier that corresponds to the single route set a start point of which is a corresponding node n of a route map.

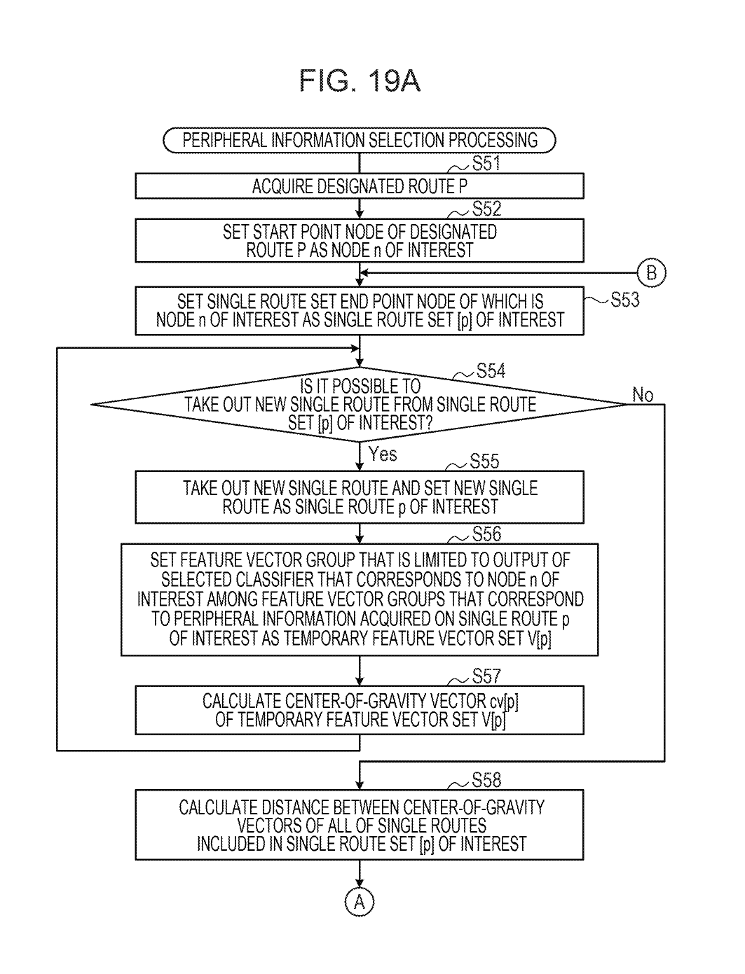

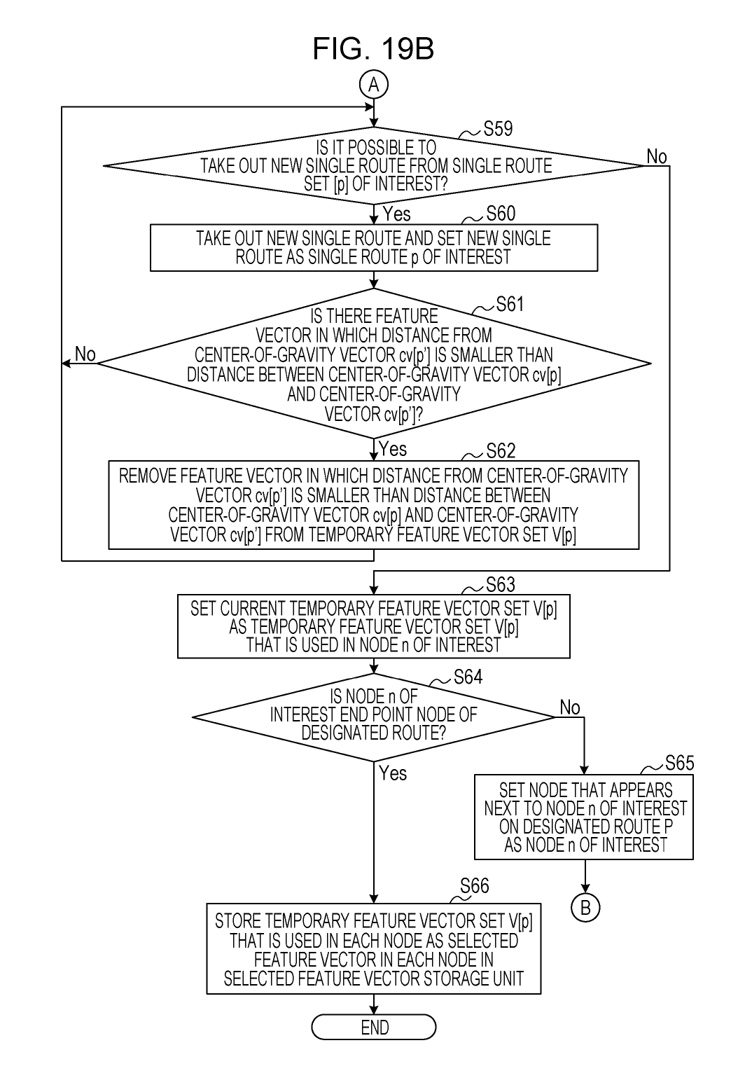

Next, peripheral information selection processing will be described. FIG. 19A and FIG. 19B are flowcharts illustrating an example of peripheral information selection processing according to the second embodiment.

The second selection unit 233 acquires a designated route P (Step S51). The second selection unit 233 sets a start point node of the designated route P as a node n of interest (Step S52). The second selection unit 233 sets a single route set a terminal point node of which is the node n of interest as a single route set {p} of interest (Step S53). The second selection unit 233 determines whether or not it is possible to take out a new single route from the single route set {p} of interest (Step S54). If the second selection unit 233 determines that it is not possible to take out a new single route from the single route set {p} of interest (NO in Step S54), the process returns to Step S58.

If the second selection unit 233 determines that it is possible to take out a new single route from the single route set {p} of interest (YES in Step S54), the second selection unit 233 takes out the new single route and sets the new single route as a single route p of interest (Step S55). The second selection unit 233 sets a feature vector group which is limited to output of a selected classifier that corresponds to the node n of interest among feature vector groups that correspond to peripheral information that has been acquired on the single route p of interest as a temporary feature vector set V[p] (Step S56). Note that the temporary feature vector set V[p] corresponds to the first feature vector set. The second selection unit 233 calculates a center-of-gravity vector cv[p] of the temporary feature vector set V[p] (Step S57) and the process returns to Step S54.

If NO in Step S54, the second selection unit 233 calculates a distance between center-of-gravity vectors of all of single routes included in the single route set {p} of interest (Step S58). The second selection unit 233 determines whether or not it is possible to take out a new single route from the single route set {p} of interest (Step S59).

If the second selection unit 233 determines that it is possible to take out a new single route from the single route set {p} of interest (YES in Step S59), the second selection unit 233 takes out the new single route and sets the new single route as the single route p of interest (Step S60). The second selection unit 233 determines whether or not there is a feature vector in which a distance from a center-of-gravity vector cv[p′] of a temporary feature vector set V[p′] to which the single route p of interest does not belong is smaller than a distance between the center-of-gravity vector cv[p] and the center-of-gravity vector cv[p′] in the temporary feature vector set V[p] of single routes included in the single route set {p} of interest (Step S61).

If the second selection unit 233 determines that there is a feature vector in which the distance is smaller than the distance between the center-of-gravity vector cv[p] and the center-of-gravity vector cv[p′] (YES in Sep S61), the second selection unit 233 removes the feature vector in which the distance is smaller than the distance between the center-of-gravity vector cv[p] and the center-of-gravity vector cv[p′] from the temporary feature vector set V[p] (Step S62) and the process returns to Step S59.

If the second selection unit 233 determines that there is not a feature vector in which the distance is smaller than the distance between the center-of-gravity vector cv[p] and the center-of-gravity vector cv[p′] (NO in Step S61), the second selection unit 233 does not remove a feature vector from the temporary feature vector set V[p] and the process returns to Step S59.

If the second selection unit 233 determines that it is not possible to take out a new single route from the single route set {p} of interest (NO in Step S59), the second selection unit 233 sets a current temporary feature vector set V[p] as the temporary feature vector set V[p] that is used in the node n of interest and the process proceeds to Step S63). The second selection unit 233 determines whether or not the node n of interest is an end point node of the designated route (Step S64). If the second selection unit 233 determines that the node n of interest is not an end point node of the designated route (NO in Step S64), the second selection unit 233 sets a node that appears next to the node n of interest on the designated route P as a node n of interest (Step S65) and the process returns to Step S53.

If the second selection unit 233 determines that the node n of interest is an end point node of the designated route (YES in Step S64), the second selection unit 233 stores the temporary feature vector set V[p] that is used in each node as a selected feature vector in each node in the selected feature vector storage unit 226 (Step S66) and peripheral information selection processing is terminated. Note that the current temporary feature vector set V[p] corresponds to the second feature vector set. Thus, the information processing device 200 is able to select a feature vector set (a selected feature vector) which corresponds to a single route set a start point (a terminal point) of which is each node n of a route map.

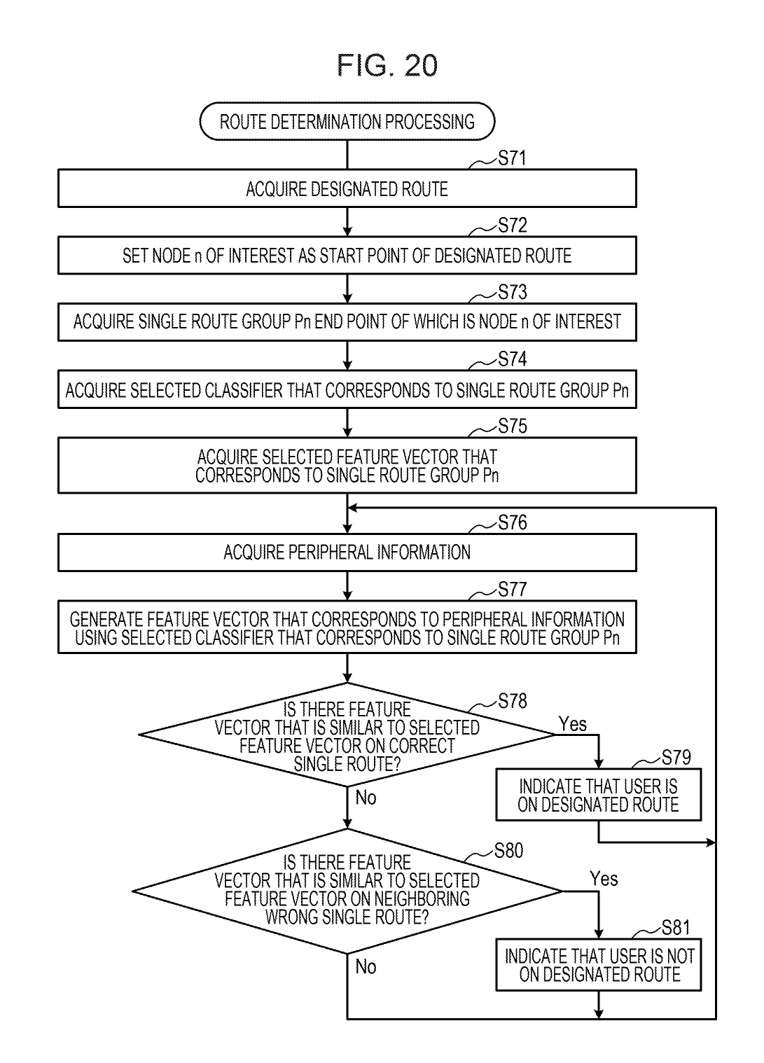

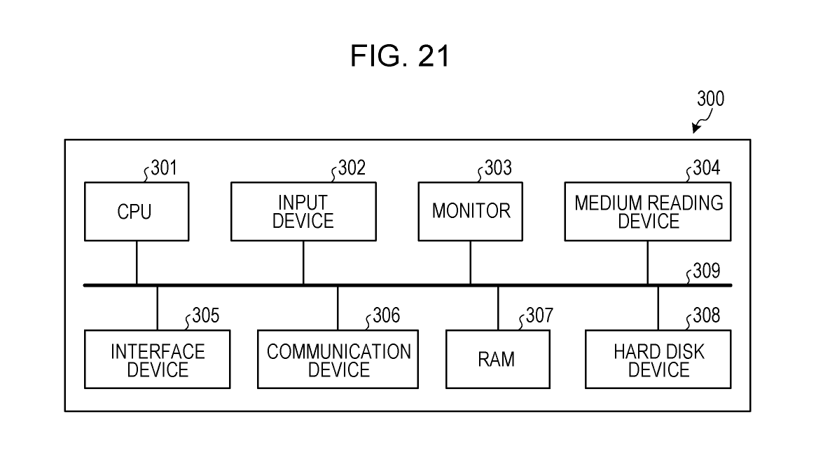

Subsequently, route determination processing will be described. FIG. 20 is a flowchart illustrating an example of route determination processing according to the second embodiment.

The determination unit 234 acquires a designated route (Step S71). The determination unit 234 sets a node n of interest as a start point of the designated route (Step S72). The determination unit 234 refers to the route map storage unit 221 and acquires a single route group Pn a terminal point of which is the node n of interest (Step S73). The determination unit 234 refers to the selected classifier storage unit 225 and acquires a selected classifier that corresponds to the single route group Pn (Step S74). Also, the determination unit 234 refers to the selected feature vector storage unit 226 and acquires selected feature vectors (the second feature vector set) which correspond to the single route group Pn (Step S75).

When input of peripheral information of a route determination subject is started, the determination unit 234 acquires the peripheral information that has been input (Step S76). The determination unit 234 generates a feature vector that corresponds to the peripheral information using the selected classifier that corresponds to the single route group Pn (Step S77). Note that feature vectors that are generated in this step include feature vectors that correspond to a correct single route and a neighboring wrong single route. The determination unit 234 determines whether or not there is a feature vector that is similar to the selected feature vector on the correct single route (Step S78). If the determination unit 234 determines that there is a feature vector that is similar to the selected feature vector on the correct single route (YES in Step S78), the determination unit 234 indicates to the user that the user is on the designated route (Step S79) and the process returns to Step S76.

If the determination unit 234 determines that there is not a feature vector that is similar to the selected feature vector on the correct single route (NO in Step S78), the determination unit 234 determines whether or not there is a feature vector that is similar to the selected feature vector on the neighboring wrong single route (Step S80). If the determination unit 234 determines that there is a feature vector that is similar to the selected feature vector on the neighboring wrong single route (YES in Step S80), the determination unit 234 indicates to the user that the user is not on the designated route (Step S81) and the process returns to Step S76.

If the determination unit 234 determines that there is not a feature vector that is similar to the selected feature vector on the neighboring wrong single route (NO in Step S80), the determination unit 234 does not indicate to the user whether or not the user is on the designated route and the process returns to Step S76. Note that, when the user reaches an end point node of the single route group Pn, the determination unit 234 sets the end point node as a node n of interest and performs route determination from the start point node to the end point node on the route map by repeating processing of Steps S72 to S81. Thus, the information processing device 200 is able to determine a current route.

As described above, the information processing device 200 assumes that centers of gravity of feature points in same classification point sets each of which is a set of feature points that have a same classification label in a feature space in which vectors are arranged in feature points are representative points and calculates a minimum distance of distances between the representative points. Also, the information processing device 200 determines whether or not the minimum distance is increased when classifiers that correspond to the feature points are removed from the first and second classifier groups. If the minimum distance is increased, as a result of determination, the information processing device 200 selects, as a specific classifier group, a classifier group from which the classifiers that correspond to the feature points have been removed. Also, if the minimum distance is not increased, as a result of determination, the information processing device 200 selects, as a specific classifier group, a classifier group from which the classifiers that correspond to the feature points have not been removed. As a result, the information processing device 200 is able to select an existing classifier that corresponds to a single route set.

Also, the information processing device 200 acquires, based on peripheral information that characterizes a designated route, a feature vector group that corresponds to the peripheral information in accordance with a single route set including a start point node of the designated route. Also, the information processing device 200 calculates each center-of-gravity vector of the first feature vector set that is a set of feature points for each same single route in a feature space in which the acquired feature vector group is arranged. Also, the information processing device 200 calculates a distance between the centers-of-gravity vectors of all of single routes included in the single route. Also, the information processing device 200 selects, among the feature vectors included in the feature vector group, the second feature vector set after removing a feature vector in which a distance from the center-of-gravity vector of the first feature vector set to which a corresponding singe route itself does not belong is smaller than the distance between the centers of gravity. Also, the information processing device 200 determines a current single route, based on the specific classifier group that has been selected and the second feature vector set that has been selected. As a result, the information processing device 200 is able to select a selected feature vector that corresponds to a single route set and is able to determine a current route using an existing classifier (the specific classifier group) and a selected feature vector (the second feature vector).

Note that, in each of the above described embodiments, as a neural network, RNN has been described as an example, but the neural network is not limited thereto. For example, it is possible to use various neural networks, such as a convolutional neural network (CNN) or the like. Also, the neural network has a multistage structure formed of, for example, an input layer, an intermediate layer (a hidden layer), and an output layer and each layer has a structure in which a plurality of nodes is connected to one another via edges. Each layer has a function called “activation function”, an edge has a “weight”, a value of each node is calculated based on a value of a node of a precious layer, and a value of a weight of a connecting edge, and the activation function that each layer has. Note that, it is possible to employ, for a calculation method, various known methods. Also, as machine learning, in addition to the neural network, various type of methods, such as a support vector machine (SVM) or the like, may be used.

Also, each component element of each unit illustrated in the drawings may not be physically configured as illustrated in the drawings. That is, specific embodiments of disintegration and integration of each unit are not limited to those illustrated in the drawings, and all or some of the units may be disintegrated/integrated functionally or physically in an arbitrary unit in accordance with various loads, use conditions, and the like. For example, the acquisition unit 131 and the selection unit 132 may be integrated. Also, the order of the respective steps illustrated in the drawings is not limited to the above-described order and, to the extent that there is no contradiction, the respective steps may be simultaneously performed and also may be performed in a different order.

Furthermore, the whole or a part of each processing function performed by each unit may be executed on a CPU (or a microcomputer, such as an MPU, a micro controller unit (MCU), or the like). Needless to say, the whole or a part of each processing function may be executed on a program that is analyzed and executed by a CPU (or a microcomputer, such as an MPU, an MCU, or the like) or a hardware of a wired logic.

Incidentally, various types of processing described in each of the above-described embodiments may be realized by causing a computer to execute a program prepared in advance. Therefore, an example of a computer that executes a program having similar functions to those described in each of the above-described embodiments will be described below. FIG. 21 is a diagram illustrating an example of a computer that executes a classifier selection program.

As illustrated in FIG. 21, a computer 300 includes a CPU 301 that executes various types of arithmetic processing, an input device 302 that receives data input, and a monitor 303. The computer 300 includes a medium reading device 304 that reads a program or the like from a storage medium, an interface device 305 that is used for providing a connection to each of various types of devices, and a communication device 306 that is used for providing a connection to another information processing device or the like via a wired or wireless communication. Also, the computer 300 includes a RAM 307 that temporarily stores various types of information and a hard disk device 308. Also, each of the devices 301 to 308 is coupled to a bus 309.

A classifier selection program that has a similar function to that of each of processing units of the acquisition unit 131, the selection unit 132, and the classification unit 133 illustrated in FIG. 1 is stored in the hard disk device 308. Alternatively, a classifier selection program that has a similar function to that of each of processing units of the acquisition unit 231, the first selection unit 232, the second selection unit 233, and the determination unit 234 illustrated in FIG. 6 is stored in the hard disk device 308.

Also, various types of data that is used for realizing the correct answer data storage unit 121, the classifier storage unit 122, the vector storage unit 123, and the selected classifier storage unit 124 illustrated in FIG. 1 and the classifier selection program are stored in the hard disk device 308. Alternatively, various types of data that is used for realizing the route map storage unit 221, the peripheral information storage unit 222, the classifier storage unit 223, the single route feature vector storage unit 224, the selected classifier storage unit 225, and the selected feature vector storage unit 226 illustrated in FIG. 6 and the classifier selection program are stored in the hard disk device 308.

The input device 302 receives, for example, an input of each of various types of information, such as operation information or the like, from an administrator of the computer 300. The monitor 303 displays, for example, various types of screens, such as a display screen or the like, to the administrator of the computer 300. For example, a print device or the like is coupled to the interface device 305. The communication device 306 has a similar function to that of the communication unit 110 illustrated in FIG. 1 or FIG. 6, is coupled to a network that is not illustrated, and exchanges various types information with another information processing device.

The CPU 301 reads each program that is stored in the hard disk device 308, develops and executes the program in the RAM 307, and thereby performs various types of processing. Also, the programs are able to cause the computer 300 to function as the acquisition unit 131, the selection unit 132, and the classification unit 133 illustrated in FIG. 1. Alternatively, the programs are able to cause the computer 300 to function as the acquisition unit 231, the first selection unit 232, the second selection unit 233, and the determination unit 234 illustrated in FIG. 6.

Note that the above described classifier selection program may not be stored in the hard disk device 308. For example, the computer 300 may be configured to read and execute a program that is stored in a storage medium from which the computer 300 is able to read the program. For example, a portable recording medium, such as a CD-ROM, a digital versatile disc (DVD), a universal serial bus (USB) memory, or the like, a semiconductor memory, such as a flash memory or the like, a hard disk drive, or the like corresponds to the storage medium from which the computer 300 is able to read the program. Also, the classifier selection program may be stored in a device that is coupled to a pubic network, the Internet, a LAN, or the like and the computer 300 may be configured to read the classifier selection program from the device and execute the classifier selection program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A classifier selection method executed by a processor included in an information processing device, the classifier selection method comprising:
providing first and second classifier groups that have been learned using a subject that is acquired from an input domain including a plurality of subjects that are to be classified;
acquiring, when correct answer data is input, a vector including evaluation values that are output by the first and second classifier groups as components; and
selecting a specific classifier group from among the first and second classifier groups, based on a dispersion relationship of the acquired vectors.

2. The classifier selection method according to claim 1,
wherein, in the selecting, a classifier group in which a dispersion of distances between feature points in a same classifier point set that is a set of feature points which have a same classification label in a feature space in which the vectors are arranged as feature points is selected as the specific classifier group.

3. The classifier selection method according to claim 2,
wherein, in the selecting, the specific classifier group is selected from a classifier group in which a dispersion of distances between feature points in the same classification point set is less than an average value.

4. The classifier selection method according to claim 2,
wherein, in the selecting, it is assumed that centers of gravity of the feature points in a plurality of the classification point sets are representative points, a minimum distance of distances between the representative points is calculated, and the specific classifier group is selected from a classifier group in which the minimum distance is an average value or more.

5. The classifier selection method according to claim 1, further comprising
classifying an input data group using the specific classifier group that has been selected.

6. The classifier selection method according to claim 1,
wherein, in the selecting, it is assumed that centers of gravity of the feature points included in a same classification point set that is a set of feature points that have a same classification label in a feature space in which the vectors are arranged as feature points are representative points, a minimum distance of distances between the representative points is calculated, it is determined, when classifiers that correspond to the feature points are removed from the first and second classifier groups, whether or not the minimum distance is increased, when the minimum distance is increased, a classifier group from which the classifiers that correspond to the feature points have been removed is selected as the specific classifier group, and, when the minimum distance is not increased, a classifier group from which the classifiers that correspond to the feature points have not been removed is selected as the specific classifier group.

7. The classifier selection method according to claim 6,
wherein, in the acquiring, based on peripheral information that characterizes a designated route, a feature vector group that corresponds to the peripheral information in accordance with a single route set that includes a start point node of the designated route is acquired,
each center-of-gravity vector of a first feature vector set that is a set of feature points for each same single route in a feature space in which the acquired feature vector group is arranged as a feature point is calculated, a distance between the centers-of-gravity vectors of all of single routes included in the single route is calculated, and a second feature vector set after removing a feature vector in which a distance from the center-of-gravity vector of the first feature vector set to which the single route itself does not belong is smaller than the distance between the centers of gravity vectors from the feature vector group is selected among the feature vectors included in the feature vector group, and
a current single route is determined based on the specific classifier group that has been selected and the second feature vector that has been selected.

8. A non-transitory, computer-readable recording medium having stored therein a program for causing a computer to execute a process comprising:
providing first and second classifier groups that have been learned using a subject that is acquired from an input domain including a plurality of subjects that are to be classified;
acquiring, when correct answer data is input, a vector including evaluation values that are output by the first and second classifier groups as components; and
selecting a specific classifier group from among the first and second classifier groups, based on a dispersion relationship of the acquired vectors.

9. An information processing apparatus comprising:
a memory configured to store first and second classifier groups that have been learned using a subject that is acquired from an input domain including a plurality of subjects that are to be classified; and
a processor coupled to the memory and configured to:
acquire, when correct answer data is input, a vector including evaluation values that are output by the first and second classifier groups as components, and
select a specific classifier group from among the first and second classifier groups, based on a dispersion relationship of the acquired vectors.

10. An information processing apparatus comprising:
a memory storing instructions; and
a processor, coupled to the memory, that executes the instructions to perform a process comprising:
establishing that centers of gravity of feature points are representative points when the feature points are included in a classification point set having a same classification label in a feature space in which vectors are arranged as the feature points;
determining distances among the representative points;
determining a minimum distance from among the distances;
determining whether the minimum distance increases when classifiers corresponding to the feature points are removed from a first classifier group and a second classifier group;
selecting a first specific classifier group from which the classifiers that correspond to the feature points have been removed when a determination is made that the minimum distance increases; and
selecting a second specific classifier group from which the classifiers that correspond to the feature points have not been removed when a determination is made that the minimum distance has not increased.
